(19) United States
(12) Patent Application Publication
(10) Pub. No.: US 2009/0005071 A1
(43) Pub. Date: Jan. 1, 2009

(54) Event Triggered Content Presentation

(75) Inventors: Scott Forstall, Mountain View, CA (US); Gregory N. Christie, San Jose, CA (US); Robert E. Borchers, Pleasanton, CA (US); Imran A. Chaudhri, San Francisco, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/054,076

(22) Filed: Mar. 24, 2008

Related U.S. Application Data
(60) Provisional application No. 60/946,895, filed on Jun. 28, 2007.

(51) Int. Cl. H04Q 7/20

(52) U.S. Cl. 455/456.1

(57) ABSTRACT

Methods, computer program products, systems and data structures for generating property instructions are described. Associated with the property instructions may include a property table. The property table may identify the detection of a particular geographic location as a trigger event, and the display of an attribute (or attributes) of a display property as an action. When a mobile device comes within a defined range of a geographic area as defined in the property table, the attribute of the display property is displayed on the mobile device.

### RELATED APPLICATION

This application claims the benefit under 35 U.S.C. §119 of U.S. Provisional Application No. 60/946,895, titled “Event Triggered Content Presentation,” filed on Jun. 28, 2007, which is incorporated by reference herein in its entirety.

### TECHNICAL FIELD

The subject matter as described herein is generally related to content presentation.

### BACKGROUND

Wireless devices including mobile phones and personal digital assistants have rapidly become an integral part of some societies. This is due in large part to the increasing number of services and functions available from the wireless industry. For example, “wireless web” services have revolutionized mobile communications by providing stock information, email capability and scheduling functions all in the palm of the user. Some graphical user interfaces for mobile devices are based on a desktop metaphor that creates a graphical environment simulating work at a desk. These graphical user interfaces typically employ a window environment. The window environment presents a user with specially delineated areas of the screen called windows, each of which is dedicated to a particular application program, file, document, or folder.

Some devices allow a user to personalize a graphical user interface based on a theme. For example, traditional themes may include celebrity icons or animated objects such as race cars, landscape themes, etc. However, these forms of personalization are static, and do not dynamically respond to the changing environment, for example, changes resulting as the user travels from one location to another location.

### SUMMARY

Methods, computer program products, systems and data structures for generating property instructions are described. Associated with the property instructions may include a property table. The property table may identify the detection of a particular geographic location as a trigger event, and the display of an attribute (or attributes) of a display property as an action. When a mobile device comes within a defined range of a geographic area as defined in the property table, the attribute of the display property is displayed on the mobile device.

In some implementations, the method includes receiving location information associated with a device, identifying an attribute of a display property corresponding to a geographic location associated with the received location information, and presenting the attribute on the device.

In another implementations, the method includes presenting a first attribute on a device, the first attributed being associated with a first location, receiving a second location associated with the device, identifying a second attribute corresponding to the second location, and presenting the second attribute on the device.

In yet another implementations, the method includes specifying a trigger event and an associated action, the action specifying a change to a presentation environment associated with a mobile device, the trigger event associated with a location of the mobile device, detecting a new location of the mobile device, determining if the new location has satisfied the trigger event, and if so, initiating the associated action including updating a presentation environment associated with the mobile device based on the action.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example mobile device.

FIG. 2 is a block diagram of an example network operating environment for the mobile device shown in FIG. 1.

FIG. 3A is a block diagram of an example implementation of the mobile device shown in FIG. 1.

FIG. 3B is an example of a property table.

FIG. 4 is a block diagram of an example positioning system of the mobile device shown in FIG. 1.

FIGS. 5A-5C illustrate examples of a mobile interface after applying an attribute based on location of the mobile device.

FIG. 6 is a flowchart illustrating an example method for presenting a theme on the mobile device shown in FIG. 1.

Like reference symbols in the various drawings indicate like elements.

### DETAILED DESCRIPTION

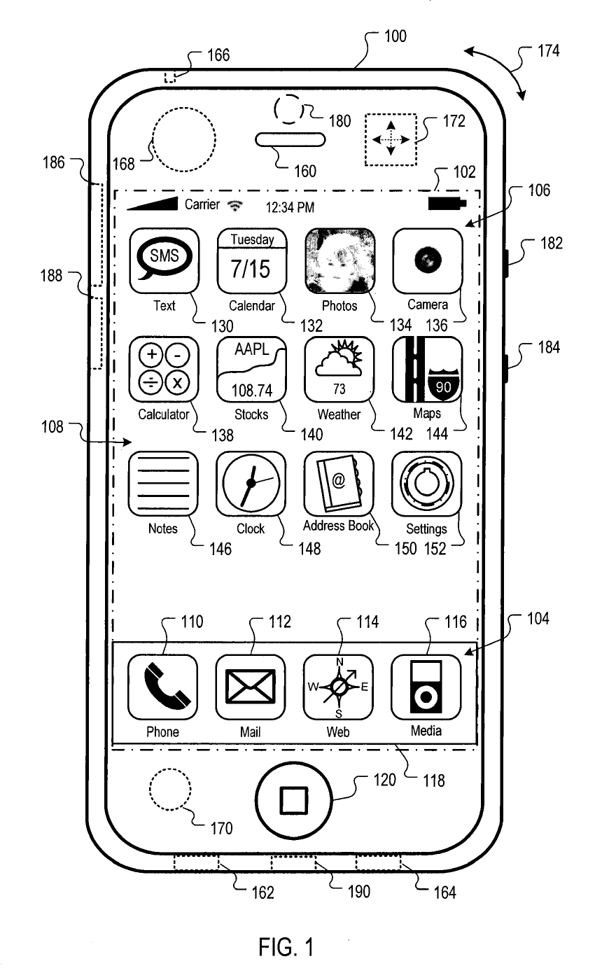

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, other electronic device or a combination of any two or more of these data processing devices or other data processing devices.

### Mobile Device Overview

The mobile device 100 may include a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree and/or position of each touch point. Such processing can be utilized to facilitate gestures and interactions with multiple fingers, chording, and other interactions. Other touch-sensitive display technologies can also be used, e.g., a display in which a point of contact corresponds to a stylus or other pointing device. An example of a multi-touch-sensitive display technology is described in U.S. Pat. Nos. 6,323,846; 6,570,557; 6,677,932; and U.S. Patent Publication No. 2002/0015024A1, each of which is incorporated by reference herein in its entirety.

In some implementations, the mobile device 100 can display one or more graphical user interfaces on the touch-sensitive display 102 for providing the user access to various system objects and conveying information to the user to facilitate an intuitive user experience. In some implementations of the graphical user interface, the touch-sensitive display 102 can, for example, include one or more display objects 104. Each of the display objects 104 can be a graphic representation of a system object. Example system objects include device functions, applications, windows, files, alerts, events, or other identifiable system objects.

### Example Mobile Device Functionality

In some implementations, the mobile device 100 can implement multiple device functionalities, such as a phone device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular device objects, e.g., the phone object 110, the e-mail object 112, the Web object 114, and the media player object 116, can be displayed in a menu bar 118. In some implementations, each of the device functionalities can be accessed from a top-level graphical user interface, such as the graphical user interface illustrate in FIG. 1. Touching one of the objects 110, 112, 114 or 116 can, for example, invoke the corresponding functionality.

In some implementations, the mobile device 100 can implement network distribution functionality. In particular, the mobile device 100 can extend Internet access (e.g., via Wi-Fi) to other wireless devices in the vicinity. For example, mobile device 100 can be configured as a base station for one or more devices. As such, mobile device 100 can grant or deny network access to other wireless devices.

Upon invocation of particular device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment of FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 134, 136, 138, 140, 142, 144, 146, 148, 150 and 152 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS). In some implementations, a positioning system (e.g., a GPS receiver) can be integrated into the mobile device 100 or provided as a separate device that can be coupled to the mobile device 100 through an interface (e.g., port device 190) to provide access to location-based services.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as a 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

In some implementations, a port device 190, e.g., a universal serial bus (USB) port, or a docking port, or some other wired port connection, can be included. The port device 190 can, for example, be utilized to establish a wired connection to other computing devices, such as other communication devices 100, a personal computer, a printer, or other processing devices capable of receiving and/or transmitting data. In some implementations, the port device 190 allows the mobile device 100 to synchronize with a host device using one or more protocols, such as, for example, the TCP/IP over USB protocol described in co-pending U.S. patent application Ser. No. 11/770,691, filed Jun. 28, 2007, for “Multiplexed Data Stream Protocol,” Attorney Docket No. 004860.P5490, which patent application is incorporated by reference herein in its entirety.

### Network Operating Environment

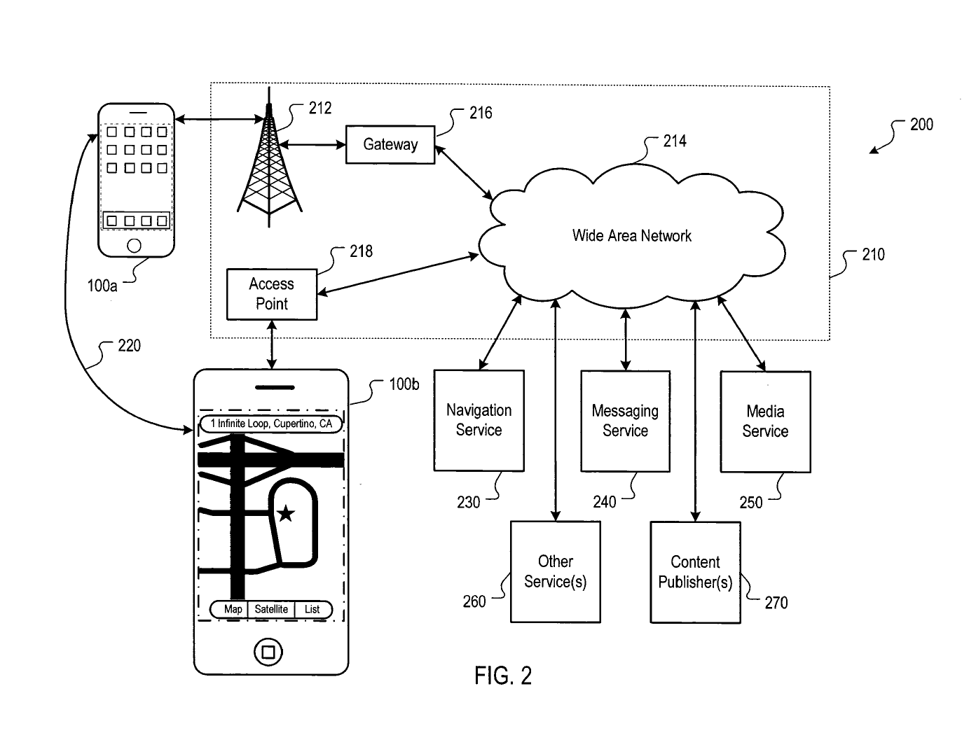

FIG. 2 is a block diagram of an example network operating environment 200 for the mobile device 100 of FIG. 1. The mobile device 100 of FIG. 1 can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access point 218, such as an 802.11g wireless access point, can provide communication access to the wide area network 214. In some implementations, both voice and data communications can be established over the wireless network 212 and the access point 218. For example, the mobile device 100a can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, the mobile device 100b can place and receive phone calls, send and receive e-mail messages, and retrieve electronic documents over the access point 218 and the wide area network 214.

The mobile devices 100a and 100b can also establish communications by other means. For example, the wireless device 100a can communicate with other wireless devices, e.g., other wireless devices 100, cell phones, etc., over the wireless network 212. Likewise, the mobile devices 100a and 100b can establish peer-to-peer communications 220, e.g., a personal area network, by use of one or more communication subsystems, such as the Bluetooth™ communication device 188 shown in FIG. 1. Other communication protocols and topologies can also be implemented.

The mobile device 100 can, for example, communicate with one or more services 230, 240, 250 and 260 and/or one or more content publishers 270 over the one or more wired and/or wireless networks 210. For example, a navigation service 230 can provide navigation information, e.g., map information, location information, route information, and other information, to the mobile device 100. In the example shown, a user of the mobile device 100b has invoked a map functionality, e.g., by pressing the maps object 144 on the top-level graphical user interface shown in FIG. 1, and has requested and received a map for the location “1 Infinite Loop, Cupertino, Calif.”

A messaging service 240 can, for example, provide e-mail and/or other messaging services. A media service 250 can, for example, provide access to media files, such as song files, movie files, video clips, and other media data. One or more other services 260 can also be utilized by the mobile device 100.

The mobile device 100 can also access other data over the one or more wired and/or wireless networks 210. For example, content publishers 270, such as news sites, web pages, developer networks, etc. can be accessed by the mobile device 100, e.g., by invocation of web browsing functions in response to a user pressing the Web object 114.

### Example Device Architecture

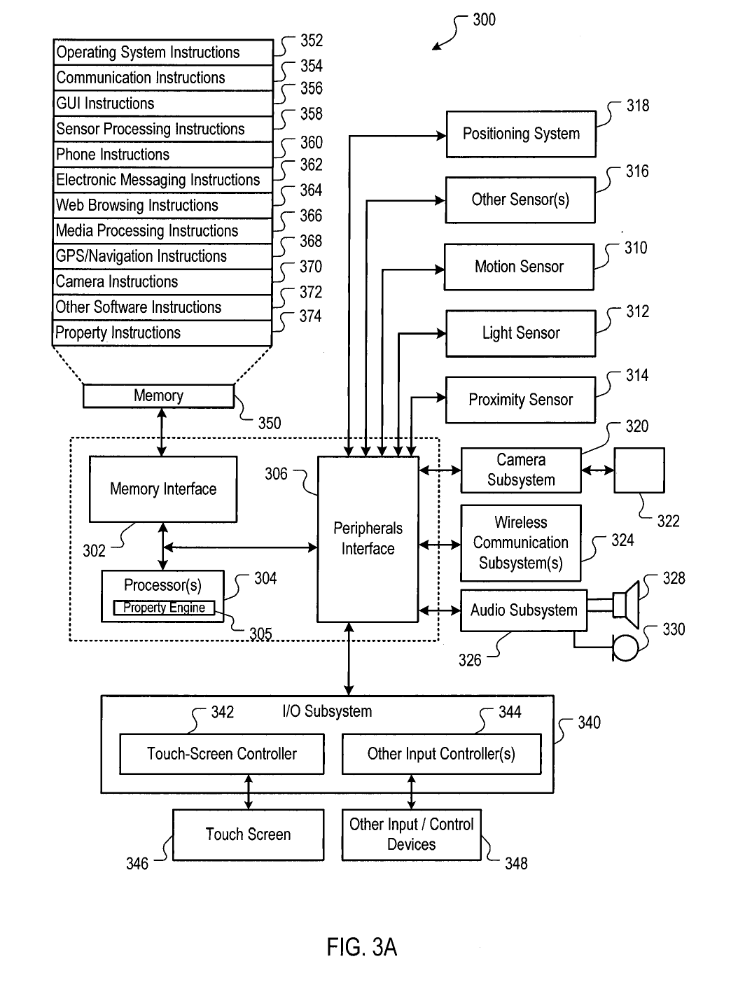

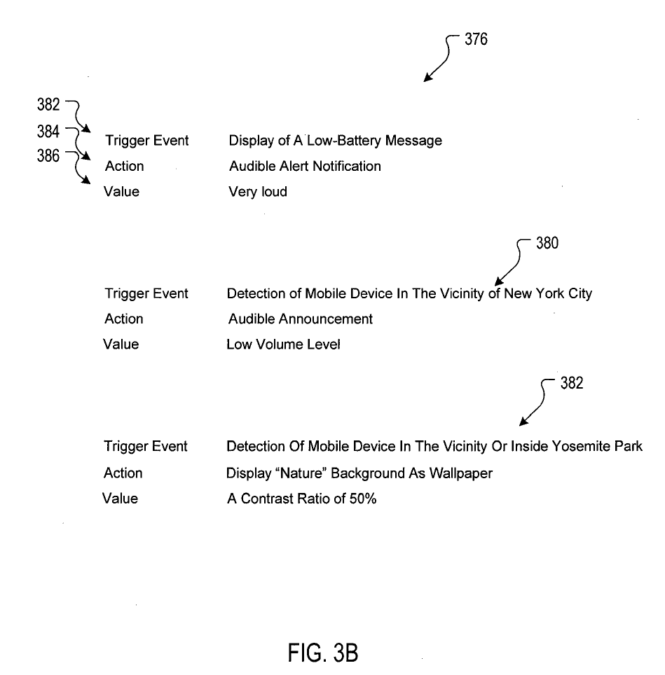

FIG. 3A is a block diagram 300 of an example implementation of the mobile device 100 of FIG. 1. The mobile device 100 can include a peripherals interface 306 and a memory interface 302 for one or more processors 304 (e.g., data processors, image processors and/or central processing units). In one implementation, the processor 304 includes a property engine 305 for executing property instructions 374 related to property-related processes and functions. The property engine 305 and property instructions 374 will be discussed in greater detail below.

The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting and proximity functions described with respect to FIG. 1. Other sensors 316 can also be connected to the peripherals interface 306, such as a GPS receiver, a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate. For example, a mobile device 100 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other technologies such as proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 on or off. The user may be able to customize a functionality of one or more of the buttons. The touch screen 346 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory. The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks.

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; other software instructions 372 to facilitate other related processes and functions; and property instructions 374 to facilitate property-related processes and functions. In some implementations, property instructions 374 may contain instructions for executing display properties. The instructions may include data associated with a property table 376. The property table 376 may contain data or information (e.g., properties, attributes, values, etc.) defining one or more display properties. In these implementations, the property engine 305 may access the property table 376, and execute a particular display property selection based on the data contained in the property table 376, as will be discussed in greater detail below.

The above identified instructions can correspond to a set of instructions for performing one or more functions described above. These instructions need not be implemented as separate software programs, procedures or modules. The memory 350 can include additional instructions or fewer instructions. Furthermore, various functions of the mobile device 100 may be implemented in hardware and/or in software, including in one or more signal processing and/or application specific integrated circuits.

### Location Detection

The mobile device 100 can include a positioning system 318 to receive positioning information. As shown, through the positioning system 318, the mobile device 100 may initially transmit a request for data (e.g., positioning data) to the wireless network 210. The wireless network 210 may include one or more base transceiver stations 212 through which data and voice communications may be transmitted or received. The one or more base transceiver stations 212 may be coupled to a base station controller (not shown), and the base station controller may connect to another network. For example, the base station controller may connect to a public switched telephone network. In any given environment, more than one wireless service provider network may exist. Other networks (wireless or wired networks) may be accessible from the wireless network 210. For example, the public switched telephone network may connect to the wide area network 214. From the wide area network 214, any of the services 230-270 may be accessible. The services 230-270 may be divided into separate systems to allow for scalability, data integrity, or data security, and each service may be connected to another network in any of a variety of ways.

In another implementations, the positioning system 318 may be in direct communication with one or more satellites which may continuously transmit signals that the mobile device 100 can use to determine precise locations. For example, the mobile device 100 may receive a plurality of GPS signals and determine a precise location of the mobile device 100 based on the received GPS signals.

During operation, the base transceiver station 212 (and base station controller) may receive a data request from the mobile device 100. Upon receipt, base transceiver station 212 may forward the data request to a public switched telephone network coupled to the wide area network 214. Over the wide area network 214, the data request is routed to the navigation service 230 (or other information providers). A server at the navigation service 230 retrieves the requested data, and provides the requested data back to the public switched telephone network through the wide area network 214. The public switched telephone network sends the retrieved data to the base transceiver station 212. The base transceiver station 212 forwards the data to the requesting mobile device 100.

In some implementations, the navigation service 230 is provided by a navigation service provider that provides software-only positioning system that leverages a database of known Wi-Fi access points to calculate a precise location of the mobile device 100 (e.g., in implementations in which the mobile device 100 is an Wi-Fi enable device). In another implementations, the navigation service 230 is provided by a navigation service provider that uses commercial broadcast TV signals to provide reliable positioning indoors and in urban environments. This navigation service provider may combine TV signals with GPS signals to provide seamless indoor/outdoor coverage across all environments for the mobile device 100.

The positioning system 318, in some implementations, can be integrated with the mobile device, or can be coupled externally to the mobile device 100 (e.g., using a wired connection or a wireless connection). The positioning system 318 may use positioning technology to display location-based information as an “intelligent default” or in response to a request or trigger event. Geographic information can be received by the positioning system 318 over a network (e.g., wide area network 214) and used to filter a repository of information. Alternatively, geographical map and routing data may be preloaded on the mobile device 100. For example, geographical map and routing data may be stored in a random access memory and/or non-volatile memory of the mobile device 100.

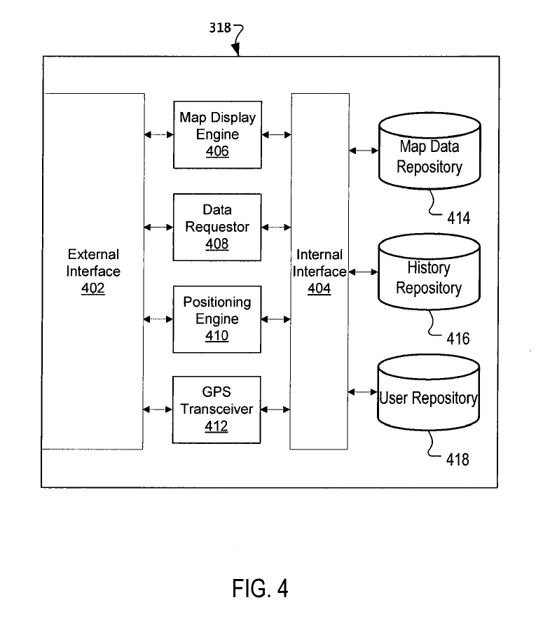

FIG. 4 illustrates components of the positioning system 318. Referring to FIG. 4, the positioning system 318 may include an external interface 402. Through the external interface 402, the positioning system 318 transmits requests and receives responses. The positioning system 318 also may include an internal interface 404 to internally route information to and from a history repository 416, map data repository 414 and user repository 418. Although the external interface 402 and the internal interface 404 are shown as distinct interfaces, they may be partially or fully combined, or they may include additional interfaces. As an example, the internal interface 404 may include interface devices for a high-speed, high-bandwidth network such as SONET or Ethernet, or any suitable communication hardware operating under an appropriate protocol such that the positioning system 318 can submit a large number of distinct requests simultaneously. The external interface 402 may include network interface cards (NICs) or other communication devices, and may similarly include components or interfaces of a high-speed, high-bandwidth network.

In some implementations, the positioning system 318 can include a global positioning system (GPS) transceiver 412 for transmitting and receiving data (e.g., GPS coordinates), a positioning engine 410 operable to derive positioning information from received GPS satellite signals, a data requestor 408 that handles a data request from a user of the mobile device 100, and a map display engine 406 that is configured to visually or audibly interpret or display positional information received from, for example, the navigation service 230. In other implementations, the positioning system 318 can include a compass, an accelerometer, as well as a other engine or instructions operable to derive precise position information. It should be noted that the precise design of the positioning system 318 may take other suitable form, and the positioning system 318 may include greater or lesser components than those shown.

In some implementations, the mobile device 100 may be a stand-alone device that relies, e.g., completely, on data stored in the map data repository 414 for geographical and other information. The map data repository 414 can have various levels of detail. In some implementations, the map data repository 414 includes geographical information at the major road level. Other information also may be included in the map data repository 414 including, without limitation, information associated with minor roads, turn restrictions, one-way streets, highway ramp configurations, hotels, restaurants, banks and other business information, traffic updates, weather information, emergency facility locations and the like. In these implementations, a user of the mobile device 100 may regularly update the map data repository 414 through the navigation service 230 to include new data not readily available, such as new road constructions and closures.

The positioning system 318 may optionally receive or request user specified or preference data for calculating a particular route. For example, the user of the mobile device 100 may want to avoid toll roads, dirt roads or major highways or travel along certain more scenic paths. In this example, the user can submit this information to the positioning system 318 (e.g., through data requestor 408) to produce a satisfactory route in real-time. The submission of such information may then be stored in a history repository 416 along with data indicative of the actual route traversed by a user in getting from a location to a destination. Data stored in the history repository 416 may be collected from previous user sessions and is accessible by the positioning system 318. Other known methods also can be used to obtain user specific information, such as searching and the like.

The mobile device 100 may be programmed or otherwise configured to automatically transmit and receive location information to and from the navigation service 230 on a periodic basis. In some implementations, the navigation service 230 may notify the mobile device 100 upon approaching a new geographic area (or departing a current geographic area). In response, the mobile device 100 may inform the user of the new geographic area. For example, the mobile device 100 may populate a message on the display 102, generate an audio sound through the speaker 328, or produce a tactile warning such as an electronic vibration to signal to the user that the mobile device 100 is entering a new geographic area. Information associated with the new geographic area may be retrieved from the navigation service 230 and, for example, stored in the map data repository 414. Alternatively, the information can be automatically displayed to the user.

In some implementations, the positioning system 318 may access the map data repository 414, rather than through the navigation service 230, to determine a geographic area of the mobile device 100. In these implementations, the positioning system 318 may compare a current location (e.g., using GPS coordinates) of the mobile device 100 with the location information stored in the map data repository 414. If the comparison indicates that the mobile device 100 is within a known geographic area, such information can be displayed/communicated to the user. For example, the map display engine 406 may visually display that the mobile device 100 is currently at the intersection between 42^{nd} street and Broadway street in Manhattan of New York. If the comparison indicates that the mobile device 100 is within an unknown geographic area, then the navigation service 230 may be queried to extract information associated with the unknown geographic area, which is subsequently stored in the map data repository 414 for future retrieval.

### Property Engine, Property Instructions and Property Table

As discussed previously, the mobile device 100 can include a property engine 305 for executing property instructions 374. In some implementations, associated with the property instructions 374 may be a property table 376. FIG. 3B shows an example of the property table 376. Referring to FIG. 3B, the property table 376 may specify one or more trigger events 382 (e.g., an event that triggers an action to be performed). A trigger event may be, for example, time or event based. A time-based event may be realized, for example, upon reaching a particular time or date (e.g., by midnight), or within a predetermined period of a specified time or date (e.g., within 30 days). An event-based trigger may be realized, for example, by a pre-specified event.

A pre-specified event may correspond to an internal event. The internal event may include one or more operations internal to the mobile device 100, such as, without limitation, receiving a low-battery warning, inputting an address entry or memo, initializing a personal reminder, generating a calendar item, or locally determining location information (e.g., using a positioning system) and the like.

A pre-specified event also may correspond to an external event. The external event may correspond to one or more operations external to the mobile device 100, such as, without limitation, moving to a defined location (e.g., entering into an area associated with a defined location), receiving an instant or E-mail message, exceeding allotted talk time, receiving a call from a particular host and the like.

The property engine 305 may allow a user to define one or more trigger events 382. For example, the property engine 305 may provide a user with the capability of creating action-based scripting (e.g., through a user interface rendered by GUI instructions 356, or through a separate user interface), and the user may have the flexibility of manually entering the parameters and criteria for each trigger event 382.

The user also may specify one or more actions 384 associated with each trigger event 382 in the property table 376. The user may first define an event (e.g., reaching a particular location), and then specify an action item to be performed when the event occurs (i.e., when the user or mobile device 100 has reached the location). For example, as shown in property table 376, the user may define an action item that includes an audible announcement (e.g., at a low volume level) when the mobile device 100 is determined to be within a proximity of New York City. Other actions such as changing a background (e.g., the wallpaper) of the user interface of the mobile device 100, video playback or other actions also are contemplated.

The user also may define more than one action or action items per trigger event. In this implementation, the additional action items also may be performed sequentially or concurrently with the first action. For example, both a short video and an audible announcement may be played when the mobile device 100 has reached a pre-specified location.

In some implementations, a value 386 is associated with an action. The value 386 may further define the action to be performed when the trigger event 382 occurs. For example, the value 386 may characterize a type of action, identify a degree or magnitude of an action, or describe an importance of the action. Using the example given above, the value 386 may indicate a volume level of the audible alert (e.g., “very loud”). As another example, the value 386 may indicate a contrast ratio of a wallpaper 108 to be applied on the user interface of the mobile device 100, as shown in the property table 382.

Alternatively, the value 386 may define rendering characteristics (e.g., font size, color, etc.) for displaying an alert associated with a given action.

In general, the property engine 305 may access the property table 376 to locate, identify, verify or confirm a trigger event. For example, the property engine 305 may first identify an event that has occurred, and access the property table 376 to determine if a user or the mobile device 100 has previously identified the event as a trigger event. If a matching event is located (e.g., a user has previously defined the event as a trigger event), the property engine 305 can perform (e.g., immediately) the action(s) associated with the trigger event.

Other implementations are possible. For example, rather than accessing the property table 376 to access a value associated with an action, the property engine 305 may acquire (continuously or randomly) behavioral information from a user as a result of past interactions to determine an appropriate action or value to be associated with a trigger. For example, if the user has previously modified the volume of the audible alert (e.g., ring tone) of the mobile device 100 to “very loud”, the property engine 305 may automatically alert the user of the low-battery status of the mobile device 100 using this volume level (i.e., without retrieving the volume level identified in the property table 376).

### Display Property Overview

In some implementations, actions may relate to the implementation of one or more display properties. The one or more display properties may include, without limitation, themes, wallpapers, screen savers, appearances, and settings. A display property may include multi-media enhancements that can be customized to suit a particular appearance or operation on the graphical user interface of the mobile device 100. For example, a display property may include one or more still images, video, sounds, animations, text and the like.

Generally, a display property can include a set of packaged attributes or elements that alters the appearance or feel of the graphical user interface (e.g., display 102) and/or audio interface of the mobile device 100. For example, a theme property may have one or more packaged themes (e.g., a “floral” theme or an “aquatic” theme) each having one or more packaged theme attributes or elements (e.g., a “daisy” button or a “tulip” background) that can transform the general appearance of the graphical user interface to another design. A wallpaper property may have a “position” packaged attribute or element (e.g., center, tile or stretch) that controls the position of a wallpaper, and a “color” packaged element that determines the color (e.g., solid color) of the wallpaper. An appearance property may have a windows and buttons style packaged attribute or element that manages the style of windows and buttons, a color scheme packaged attribute or element that adjusts the color of windows and buttons, and a font size packaged attribute or element that administers the size of text. A settings property may have a screen resolution packaged attribute or element that handles the screen solution of the mobile device 100 (e.g., 1024×768 pixels) and a color quality packaged attribute or element that controls the number of bits (e.g., 32-bit or 16-bit) of information used to represent a single color pixel on the display 102.

When triggered, these actions (e.g., the packaged attributes/elements described above) may modify settings and/or registry files of the mobile device 100 to indicate the elements to be used by, for example the property engine 305 or the operating system of the mobile device 100 in producing a unique interface associated with the trigger. As an example, assuming that a user has associated a “Space” theme (an action), which may include a preset package containing various theme elements (e.g., a “Sun” taskbar, a “Mercury” background image, a “Venus” icon, etc.), with the determination that the device has arrived at a particular location (e.g., home), the property engine 305 can initiate the display of the “Space” theme including all of its constituent elements upon arrival at the specified location. Further detail regarding the implementation of display properties based on location will be provided below.

Of course, actions or triggers other than those described above also can be defined. For example, other actions can include other non-display based actions (e.g., playing an audible file when arriving at a destination, shutting the mobile device down when arriving at a destination, switching modes of operation (e.g., turning off the wireless capability of the mobile device or placing the mobile device in airplane mode when reaching an airport)). Other triggers can include non-location based triggers (e.g., upon initiation of an action, upon detection of an alarm, upon detection of an event (e.g., display of a password expiration message, etc), one or more actions can be initiated (e.g., the “Space” theme can be initiated)).

One or more of the display properties can be configured (e.g., by the user or the device) so as to uniquely enhance the device (e.g., the graphical user interface of the mobile device 100) by, for example, altering various sensory elements of the interface. A user may personalize the graphical user interface of the mobile device 100 by combining components from various properties, such as color scheme for buttons and font styles for text.

In some implementations, the property table 376 may be stored in a property repository (e.g., as part of or separate from the memory interface 302). The property repository may store a collection of packaged elements (e.g., theme elements, screen saver elements) that can be used for the mobile device 100. For example, the property repository may store therein still image files (e.g., jpeg, bitmap, gif, tiff or other suitable image format), video files (e.g., MOV, MPEG or AVI), text, animations and the like associated with a theme. The packaged elements may come pre-loaded on the mobile device 100, may be loaded into the memory of the mobile device 100 from external devices (e.g., flash drives), or downloaded from third party sources. The packaged elements stored in the property repository may be sorted and categorized according to a size, date or type if desired.

In certain implementations, an application (e.g., an applet) may be generated by the property instructions 374 to assist the user of the mobile device 100 in selecting and applying a desired display property to the graphical user interface. As an example, a themes applet may be generated by the execution of certain display property instructions in aiding the user to select a particular theme. The applet installation may be facilitated, for example, by the GUI instructions 356. In the foregoing example, the themes applet may provide a dialog window which presents a list of available themes, and may have controls which the user can activate to select a theme, preview a selected theme and apply the selected theme to the graphical user interface. When applied to the graphical user interface, the applied theme changes, for example, the wallpaper of the mobile device 100, the appearance of the display objects 130-152, and other interface elements, resulting in an interface appearance that is consistent with the selected theme. As an example, the selection of a “Nature” theme changes the wallpaper 108 of the mobile device 100 to a graphical image that includes trees, forests and plants, or changes other elements such as the display objects 130-152 to like enhancements related to and consistent with the nature.

### Applying Display Property Based on Location

As discussed previously, the property table 376 may indicate a trigger event and an associated action and value. In some implementations, the property table 376 may identify, for example, the detection of a particular geographic location as a trigger event, and the display of an attribute (or attributes) of a display property as an action. Specifically, when the mobile device 100 comes within a defined range of a geographic area (known or unknown), the navigation service 230 may transmit a signal to the mobile device 100 over the wide area network 214. The signal may be transmitted in response to the detection of an entry into a city, state, country, building, campus, stadium, park or other establishment. The signal may be presented in the form of a command (and interpreted as a trigger event) that instructs the mobile device 100 to activate, disable, or modify, for example, one or more attributes of a display property on the mobile device 100 when the mobile device 100 is determined to be within a defined geographic area. Alternatively, a particular attribute of the display property on the mobile device 100 may be activated, disabled or modified when the positioning system 318 detects a known geographic area, for example, based on data stored in the map data repository 414.

For example, the user may associate a national park such as Yosemite Park in California with a “nature” background such that when the mobile device 100 is within the vicinity of or inside the Yosemite Park, the property engine 305 automatically displays a “nature” background as the wallpaper 108. As another example, the user may associate the country “Costa Rica” with a “Tropical fruit” menu such that when the mobile device 100 is within the vicinity of or inside “Costa Rica”, the menu bar 118 is replaced with a new “Tropical fruit” menu bar. As yet another example, the user may associate the state of “Colorado” with a “Snowman” audio file such that when the mobile device 100 is within the vicinity of or inside the state of “Colorado”, the mobile device 100 plays the “Snowman” audio file.

In these implementations, upon receiving geographic location information of the mobile device 100 (through the navigation service 230 or positioning engine), the positioning system 318 may identify a corresponding geographic area associated with the received location information, and relay the geographic area information to the property engine 305. The property engine 305 may access the property table 376 and match the received geographic area data with the geographic requirement, if any, specified in any of the trigger events. If a match is found, the corresponding action (e.g., attribute of a display property) is identified, and presented on (or in association with) the graphical user interface of the mobile device 100. If a match is not found, a default action (e.g., as pre-selected by a user) may be retrieved and initiated. In some implementations, no action may be specified. If desired, a user may additionally define criteria other than those in the property table 376 for performing a particular action based on location of the mobile device 100.

Through this process, the mobile device 100 may be programmed or otherwise configured to present a predefined attribute of a display property based on the location of the mobile device 100. The predefined attribute also may be applied to the graphical user interface of the mobile device 100 as or upon the user entering a known geographic region. In this manner, as the user enters a geographic region, the mobile device 100 may automatically present and display the attribute of the corresponding display property associated with the geographic region.

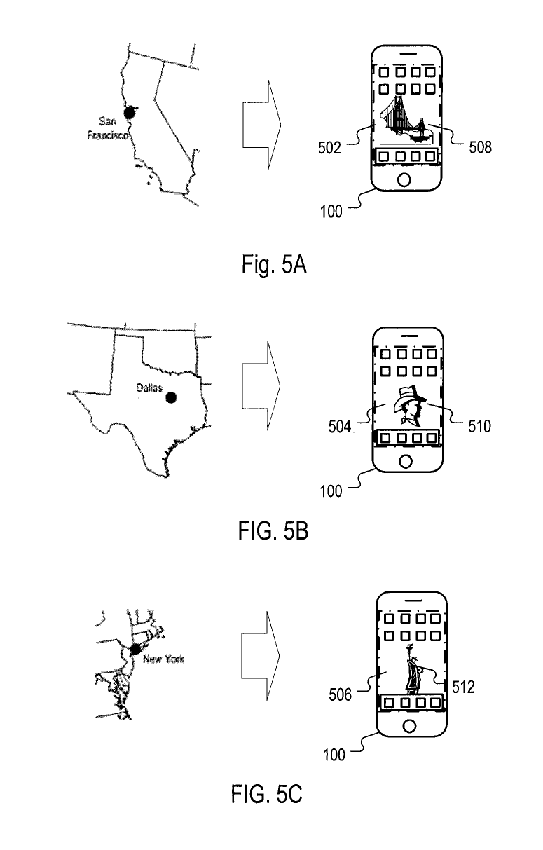

FIGS. 5A-5C illustrates an example of a user interface of a mobile device after applying an attribute of a display property based on location of the mobile device. For the purpose of explanation and sake of brevity, the following description refers to applying a wallpaper image. However, this example is in no way intended to be limiting to only wallpaper, and that other display properties and packaged attributes and elements or other actions also are possible.

Upon start up, at least one image file may be supplied and displayed as the wallpaper 502-506 on the mobile device 100 by for example, the property engine 305. Alternatively, the property engine 305 may be manually activated by a user (e.g., through standard graphical user interface). Once activated, the property engine 305 displays an image 508-512 as a wallpaper 502-506 on the display 102. The wallpaper 502-506 may be displayed in the background so as not to obscure interface elements displayed on the display 102.

As shown in FIG. 5A, the mobile device 100 is located in the city of “San Francisco” (or proximity thereof). The mobile device 100 may receive such positional information from the positioning system 318. For example, the positioning system 318 may query the map data repository 414 to retrieve data sufficient to identify the location of the mobile device 100.

The mobile device 100 also may receive the geographical coordinates of the mobile device 100 by submitting data request to the navigation service 230. The navigation service 230 may be alerted to the presence of the mobile device 100 in the city of “San Francisco”. In response, the navigation service 230 may transmit a command signal to the mobile device 100 to retrieve the image 508 to be used as the wallpaper 502 on the mobile device 100. Alternatively, the command signal may be generated by the mobile device 100 after receiving geographic location information from the navigation service 230, and processed by the display property engine.

If a property table 376 has already been established by the user of the mobile device 100, the property engine 305 may access the property table 376 and match the received geographic area corresponding with the received geographic location information with those defined in the property table. In the example shown, assuming that the property table associates the city of “San Francisco” with the image 508 depicting the “Golden Gate Bridge”, then the property engine 305 may identify this relationship, and display the image 508 as the wallpaper 502 on the mobile device 100.

Referring to FIG. 5B, the mobile device 100 is located in the city of “Dallas” (or proximity thereof). Again, the mobile device 100 may receive such positional information from the positioning system 318, or as a result of a query to the map data repository 414. The property engine 305 may subsequently be instructed by the mobile device 100 to access the property table, and match the city of “Dallas” with information defined in the property table. If a match is found, the corresponding image is retrieved. As shown, the image 510 depicting a “Cowboy” is retrieved and displayed as the wallpaper 504 on the mobile device 100.

The positioning system 318 may be in constant and continuous communication with the navigation service 230 or the map data repository 414 to identify the precise location of the mobile device 100. As the mobile device 100 moves across to another region, city or state, the precise location is identified to ensure that the image displayed as the wallpaper on the mobile device 100 is relevant.

Referring to FIG. 5C, the mobile device 100 has moved from the city of “Dallas” to the city of “New York”. Once the coordinate position of the mobile device 100 is confirmed, the property engine 305 may be instructed to retrieve a new or existing image associated with the city of “New York”. Assuming that the user of the mobile device 100 defines in the property table the association between the city of “New York” and the image 512 depicting the Statue of Liberty, the property engine 305 may retrieve and display the image 512 as the wallpaper 508 on the mobile device 100.

The property engine 305 may alert the user that new image files are available, and may be delivered in a number of ways, such as with software update. The user may run the software update to add new image files to the existing image file collection, and replace the image 508 that is currently being used by the mobile device 100 as the wallpaper 502.

New and existing image files associated with the images 508-512 may be stored as a collection. The image files may be stored in a local memory, and sorted by, for example, media types such as, without limitation, clip arts, photos, sounds and animation, or categories such as, without limitation, color (e.g., black and white) and types (e.g., food, people, cities, etc.).

Although the above examples are described with respect to images used as wallpapers, other audio or visual applications also are contemplated including, for example, ring tones. As an example, a “FurElise” ring tone may be played when the mobile device 100 comes within a predefined range of a concert hall. As another example, a “Star Spangled Banner” ring tone may be played when the mobile device 100 is detected in U.S.A., and dynamically changed to “O'Canada” when the mobile device 100 is detected in Canada. Other applications such as personal picture (e.g., sent with each call) or video content (e.g., radio, stock quotes, news, weather, and advertisements) also are contemplated.

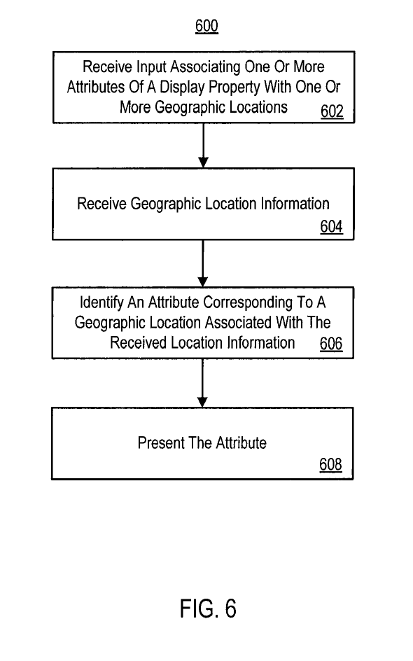

FIG. 6 is a flowchart illustrating an example process 600 for presenting a theme on the mobile device shown in FIG. 1.

Referring to FIG. 6, the process 600 includes receiving input associating one or more attributes of a display property with one or more geographic locations (602). The input may include user-defined data that defines the association between the one or more attributes with one or more geographic location. For example, the input may associate a “Dragon” background image with the country of “China”, a “Auguste Rodin” button with the country of “France”, a “Jazz” ring tone with the city of “New Orleans”, and a “Sears Tower” taskbar with the city of “Chicago”.

The process 600 also includes receiving geographic location information (604), for example, from a positioning system that is in communication with the mobile device. Through the positioning system, the mobile device may receive geographic coordinates associated with the location of the mobile device. The positioning system may be in direct communication with one or more satellites which may continuously transmit signals that the mobile device can use to determine precise locations. For example, the mobile device may receive a plurality of GPS signals and determine a precise location of the mobile device 100 based on the received GPS signals. Alternatively, the positioning system may be in communication with a navigation service provider that provides and pinpoints the location of the mobile device.

Process 600 includes identifying an attribute corresponding to a geographic location associated with received geographic location information (606). For example, process 600 may identify the “Jazz” ring tone if the received geographic location information indicates that the mobile device is in the city of “New Orleans”, or the “Dragon” background image if the received geographic location information indicates that the mobile device is in the country of “China”. The identified attribute is subsequently presented on the mobile device (608).

In some implementations, operations 602-608 may be performed in the order listed, in parallel (e.g., by the same or a different process, substantially or otherwise non-serially), or in reverse order to achieve the same result. In another implementations, operations 602-608 may be performed out of the order shown. The order in which the operations are performed may depend, at least in part, on what entity performs the method. For example, process 604 may receive geographic location information of the mobile device prior to receiving input associating one or more themes with one or more geographic locations. Operations 602-608 may be performed by the same or different entities.

The systems and methods disclosed herein may use data signals conveyed using networks (e.g., local area network, wide area network, internet, etc.), fiber optic medium, carrier waves, wireless networks (e.g., wireless local area networks, wireless metropolitan area networks, cellular networks, etc.), etc. for communication with one or more data processing devices (e.g., mobile devices). The data signals can carry any or all of the data disclosed herein that is provided to or from a device.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention. Accordingly, other implementations are within the scope of the following claims.

What is claimed is:

1. A method comprising:
receiving location information associated with a device;
identifying an attribute of a display property corresponding to a geographic location associated with the received location information; and
presenting the attribute on the device.

2. The method of claim 1, wherein receiving location information includes receiving location information from a positioning system.

3. The method of claim 2, wherein the positioning system derives location information from satellite data received from a plurality of satellites.

4. The method of claim 2, wherein the positioning system uses a wireless signal strength of the device to derive the location information.

5. The method of claim 1, wherein the display property includes one of themes, wallpapers, screen savers, appearance or settings.

6. The method of claim 2, wherein receiving location information includes receiving an instruction signal from the positioning system, and wherein identifying an attribute includes identifying the attribute in response to the instruction signal.

7. The method of claim 1, further comprising:
receiving input specifying an association between the attribute and the geographic location,
wherein identifying an attribute corresponding to a geographic location includes matching the attribute with the geographic location based on the association.

8. A method comprising:
presenting a first attribute on a device, the first attributed being associated with a first location;
receiving a second location associated with the device;
identifying a second attribute corresponding to the second location; and
presenting the second attribute on the device.

9. The method of claim 8, wherein presenting the second attribute on the device includes replacing the first attribute with the second attribute.

10. A method comprising:
specifying a trigger event and an associated action, the action specifying a change to a presentation environment associated with a mobile device, the trigger event associated with a location of the mobile device;
detecting a new location of the mobile device;
determining if the new location has satisfied the trigger event; and if so,
initiating the associated action including updating a presentation environment associated with the mobile device based on the action.

11. A system comprising:
a positioning system operable to receive or generate location information associated with a device;
a display property engine operable to manage one or more display properties and associated attributes stored on the device; and
a communication interface operable to forward location information associated with the device to the display property engine,
wherein the display property engine is configured to present at least one attribute on the device in response to the location information.

12. A system comprising:
a processor;
a computer-readable medium coupled to the processor and including instructions, which, when executed by the processor, causes the processor to perform operations comprising:
receiving location information associated with a device;
identifying an attribute of a display property corresponding to a geographic location associated with the received location information; and
presenting the attribute on the device.

13. A system comprising:
a processor;
a computer-readable medium coupled to the processor and including instructions, which, when executed by the processor, causes the processor to perform operations comprising:
presenting a first attribute on a device, the first attributed being associated with a first location;
receiving a second location associated with the device;
identifying a second attribute corresponding to the second location; and
presenting the second attribute on the device.

14. A system comprising:
a processor;
a computer-readable medium coupled to the processor and including instructions, which, when executed by the processor, causes the processor to perform operations comprising:
specifying a trigger event and an associated action, the action specifying a change to a presentation environment associated with a mobile device, the trigger event associated with a location of the mobile device;
detecting a new location of the mobile device;
determining if the new location has satisfied the trigger event; and if so,
initiating the associated action including updating a presentation environment associated with the mobile device based on the action.

15. A computer-readable medium having instructions stored thereon, which, when executed by a processor, causes the processor to perform operations comprising:
receiving location information associated with a device;
identifying an attribute of a display property corresponding to a geographic location associated with the received location information; and
presenting the attribute on the device.

16. A computer-readable medium having instructions stored thereon, which, when executed by a processor, causes the processor to perform operations comprising:
presenting a first attribute on a device, the first attributed being associated with a first location;
receiving a second location associated with the device;
identifying a second attribute corresponding to the second location; and
presenting the second attribute on the device.

17. A computer-readable medium having instructions stored thereon, which, when executed by a processor, causes the processor to perform operations comprising:
specifying a trigger event and an associated action, the action specifying a change to a presentation environment associated with a mobile device, the trigger event associated with a location of the mobile device;
detecting a new location of the mobile device;
determining if the new location has satisfied the trigger event; and if so,
initiating the associated action including updating a presentation environment associated with the mobile device based on the action.

18. A system comprising:
means for receiving location information associated with a device;
means for identifying an attribute of a display property corresponding to a geographic location associated with the received location information; and
means for presenting the attribute on the device.

19. A system comprising:
means for presenting a first attribute on a device, the first attributed being associated with a first location;
means for receiving a second location associated with the device;
means for identifying a second attribute corresponding to the second location; and
means for presenting the second attribute on the device.

20. A system comprising:
means for specifying a trigger event and an associated action, the action specifying a change to a presentation environment associated with a mobile device, the trigger event associated with a location of the mobile device;
means for detecting a new location of the mobile device;
means for determining if the new location has satisfied the trigger event; and if so,
means for initiating the associated action including updating a presentation environment associated with the mobile device based on the action.
